(19) United States
(12) Patent Application Publication
(10) Pub. No.: US 2026/0217157 A1
(43) Pub. Date: Jul. 30, 2026

(54) VEHICLE WITH CONFIGURABLE POWER SOURCE

(71) Applicant: Donald Meinhardt, Cokato, MN (US)

(72) Inventor: Donald Meinhardt, Cokato, MN (US)

(21) Appl. No.: 19/453,290

(22) Filed: Jan. 20, 2026

Related U.S. Application Data
(63) Continuation-in-part of application No. 17/865,879, filed on Jul. 15, 2022, now Pat. No. 12,552,477.

(51) Int. Cl. B60N 2/02; B60K 6/12; B60K 6/24; B60K 6/26; B60K 6/36; B60K 6/50; B60K 15/03; B60N 2/16

(52) U.S. Cl. CPC B60N 2/02246; B60K 6/12; B60K 6/24; B60K 6/26; B60K 6/36; B60K 6/50; B60K 15/03; B60N 2/16

(57) ABSTRACT

A vehicle with a frame, wheels, and a movable chair mechanism. The vehicle includes a configurable propulsion system which may comprise an electric motor, an internal combustion engine, or a hybrid combination thereof. The internal combustion engine configuration includes a fuel tank, fuel delivery system, and is integrated with the vehicle's control systems to provide extended operational range. The drivetrain may comprise a conventional transmission, independent hydraulic motors enabling zero-turn capability, or independent electric motors powered by an engine-driven generator. In some embodiments, the vehicle further comprises rear wheels movably connected to the frame to allow for an adjustable track width.

### CROSS-REFERENCE TO RELATED APPLICATIONS

This application is a continuation-in-part of U.S. patent application Ser. No. 17/865,879, filed Jul. 15, 2022, entitled “Incredible Vehicle And Incredible Vehicle Four Wheel Version,” which is a continuation-in-part of U.S. patent application Ser. No. 17/503,279, filed Oct. 16, 2021. The entire contents of both applications are hereby incorporated by reference in their entirety.

### STATEMENT REGARDING FEDERALLY SPONSORED RESEARCH

Not Applicable

### FIELD OF THE INVENTION

This invention relates to vehicles with movable operator chairs, and more particularly to such vehicles that can be configured with various power sources, including internal combustion engines as an alternative or supplement to electric motor power sources.

### BACKGROUND OF THE INVENTION

As described in parent application Ser. No. 17/865,879, incorporated herein by reference, vehicles with movable chair mechanisms enable operators to perform tasks at ground level or elevated positions without the backbreaking physical strain of traditional manual methods. The parent application describes an electric battery powered vehicle with a movable chair mechanism that can move both vertically and horizontally within an operator compartment.

While electric battery powered vehicles offer advantages such as quiet operation and zero direct emissions, there remains a need for vehicles that can be configured with alternative power sources to address different operational requirements. Internal combustion engines provide extended operational range, rapid refueling capability, and consistent performance, making them suitable for outdoor applications and remote locations. Hybrid systems can offer the benefits of both.

The present invention addresses this need by providing a versatile vehicle platform that incorporates the movable chair mechanism of the parent applications while expanding the range of power sources to include internal combustion engines and hybrid systems.

### BRIEF SUMMARY OF THE INVENTION

The present invention provides a vehicle comprising a frame defining an operator compartment, a plurality of wheels connected to the frame, and a movable chair mechanism as described in the parent applications, with the addition of alternative power source configurations.

In one aspect, the invention provides a vehicle with a propulsion system that can be configured as a pure electric system, an internal combustion engine system, or a hybrid system. The internal combustion engine may be a gasoline, diesel, or other combustion-based power source, operatively coupled to at least one driven wheel through a drivetrain.

The internal combustion engine configuration includes a fuel tank, a fuel delivery system, and an exhaust system. The engine is integrated with the vehicle's control systems and provides power for vehicle propulsion and for operation of the movable chair mechanism. In some embodiments, the drivetrain may be mechanical, hydraulic, or a series-electric configuration with a generator.

In another aspect, the invention provides a vehicle having an adjustable rear wheel track, allowing the distance between the rear driven wheels to be modified to suit different applications, such as accommodating various crop row spacings. This feature is combined with the movable chair and a versatile propulsion system.

### BRIEF DESCRIPTION OF THE DRAWINGS

The drawings of parent application Ser. No. 17/865,879 and parent application Ser. No. 17/503,279 are incorporated herein by reference and illustrate the basic vehicle structure.

FIG. 1 is a right, front and top view of the vehicle.

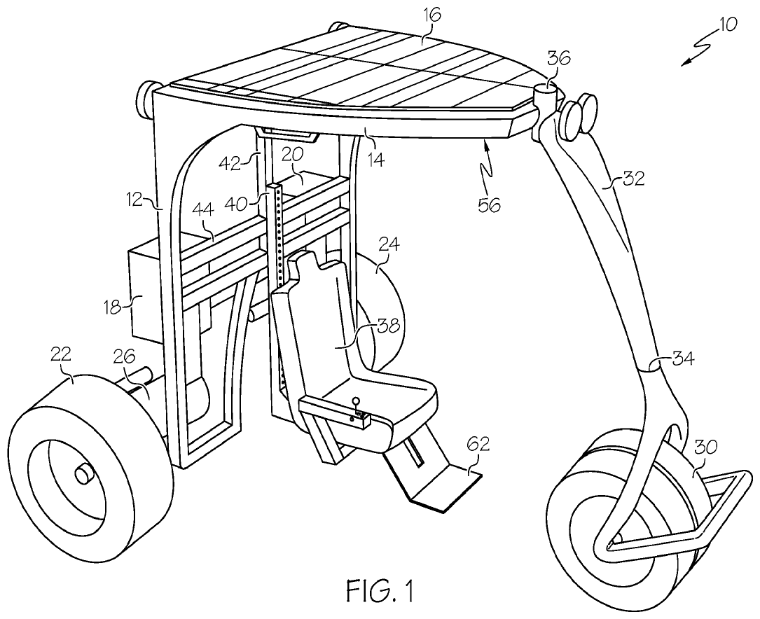

FIG. 2 is a different right, front and top view.

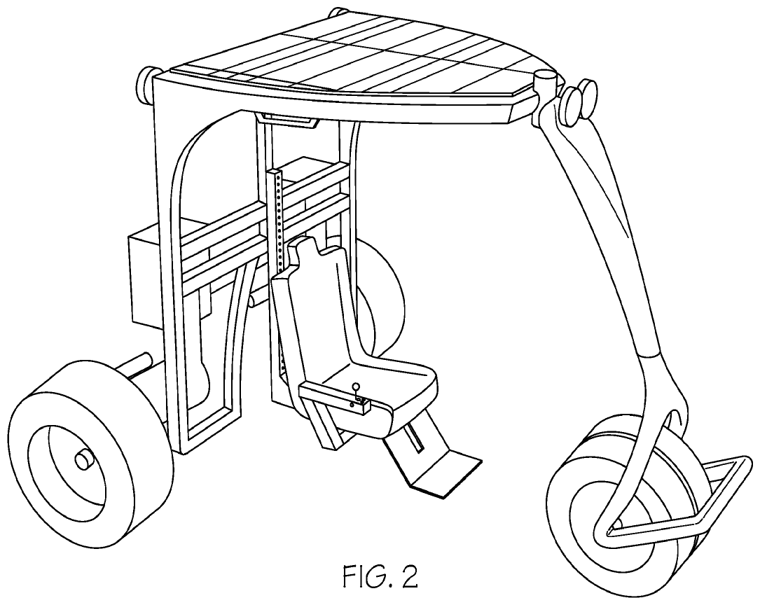

FIG. 3 is a front view.

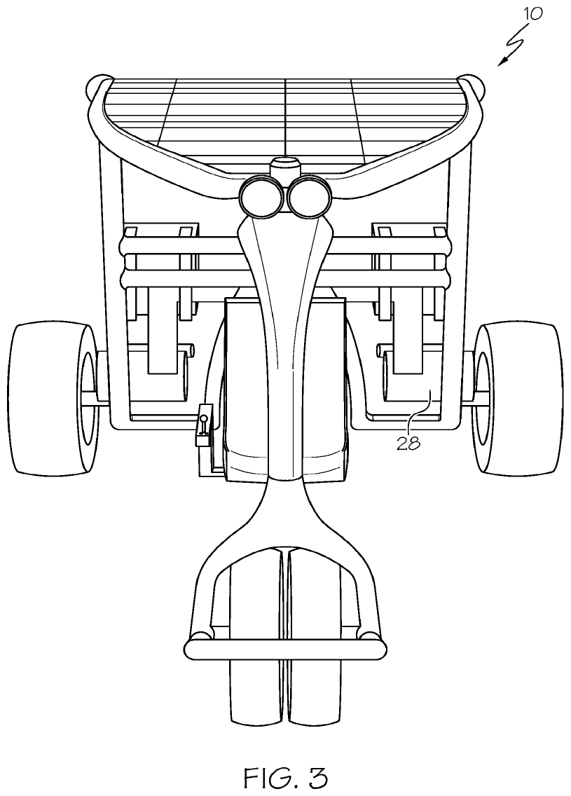

FIG. 4 is a rear view.

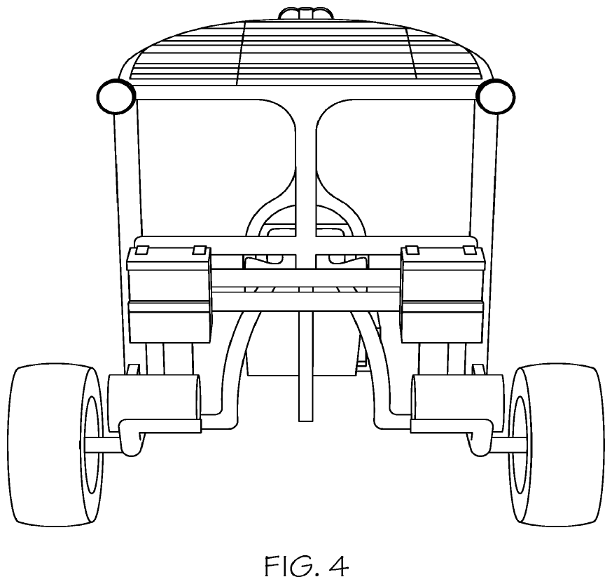

FIG. 5 is a block diagram of the invention.

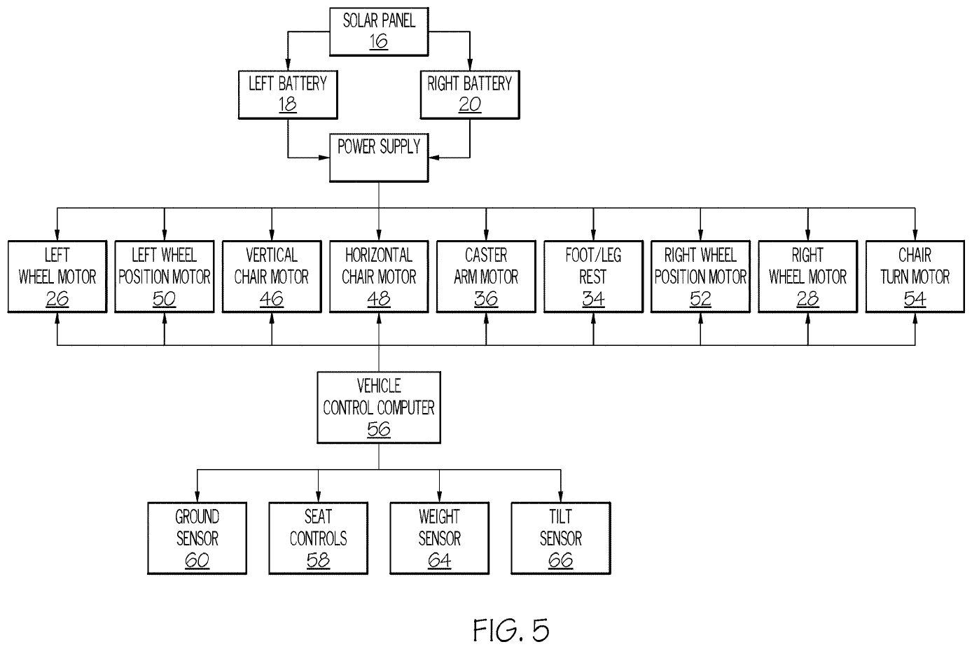

FIG. 6 shows the chair in the upper position.

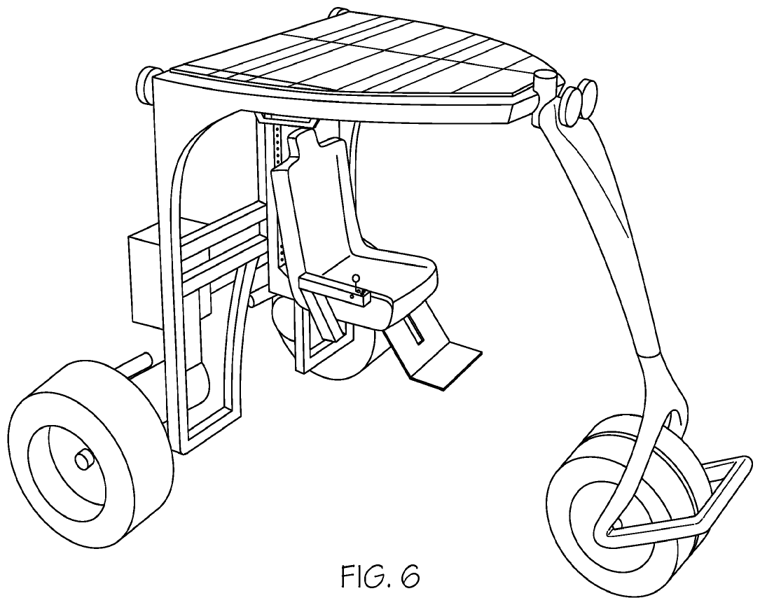

FIG. 7 shows the chair moved to the left side (looking back at the vehicle from the front end).

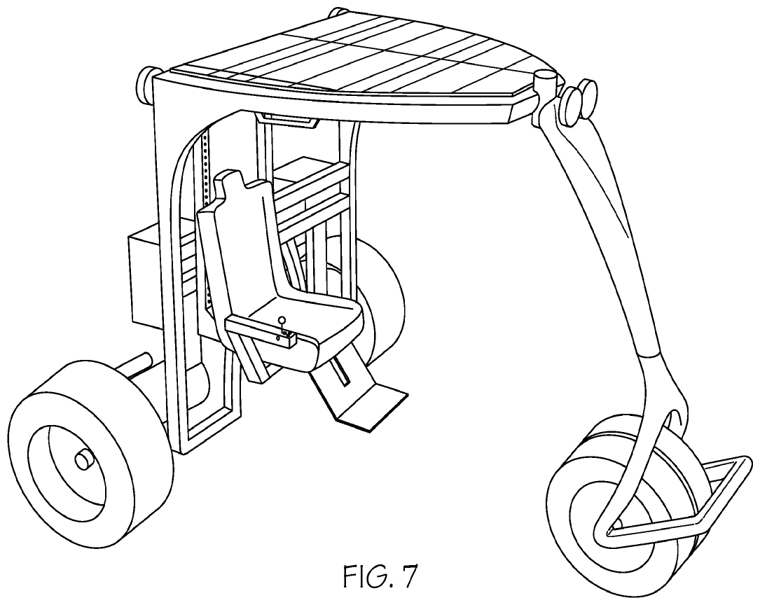

FIG. 8 shows the chair moved to the upper right side.

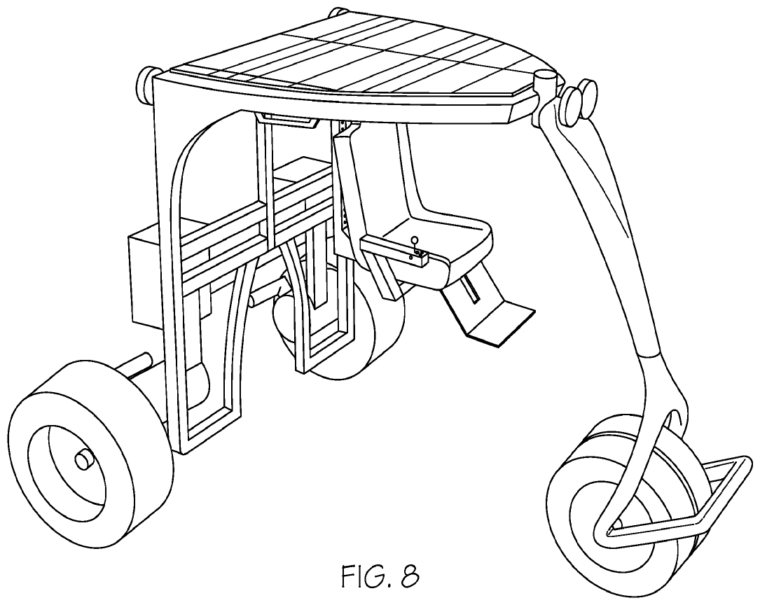

FIG. 9 shows the chair moved to the lower left side.

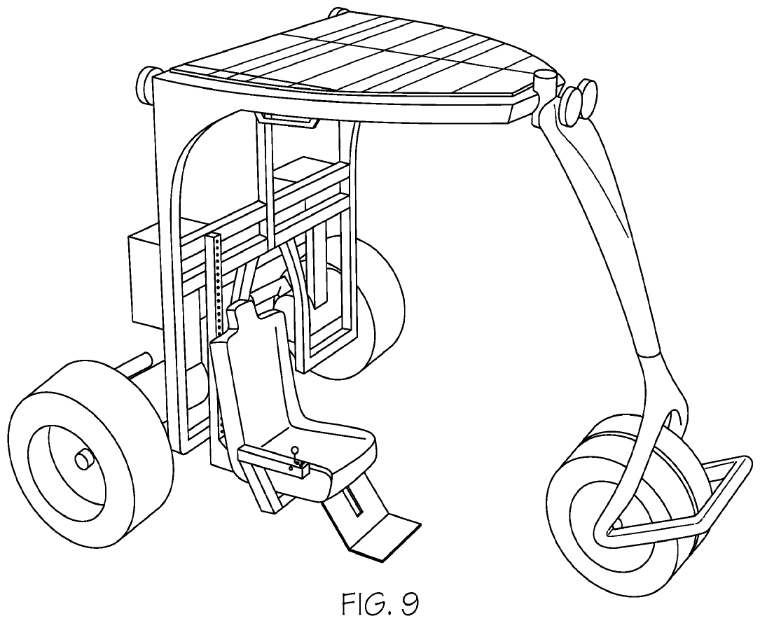

FIG. 10 shows the caster arm moved to the left (looking back at the vehicle from the front end).

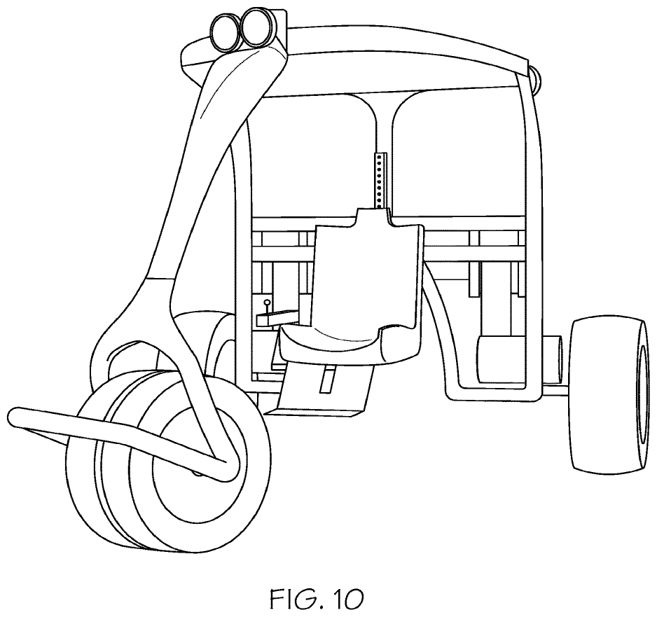

FIG. 11 shows the caster arm moved to the right.

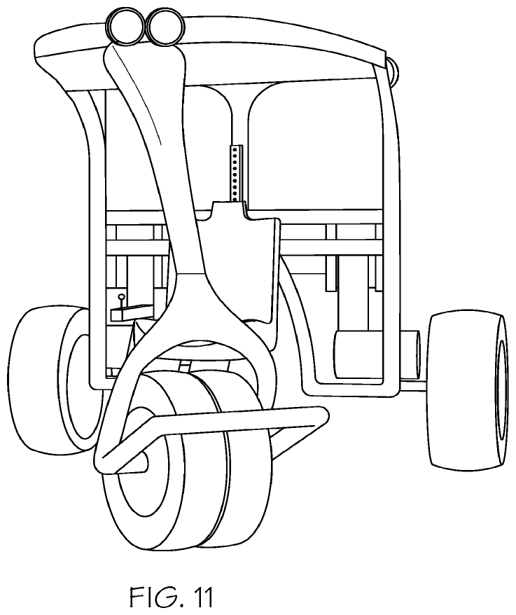

FIG. 12 shows the caster wheel rotating relative to the caster arm.

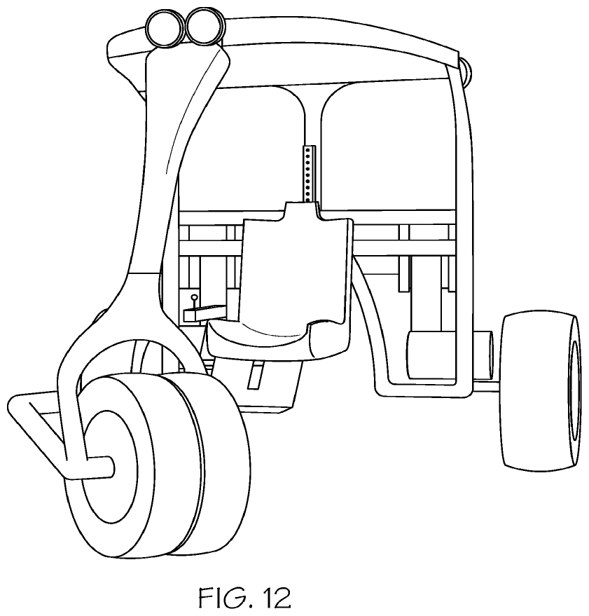

FIG. 13 shows the vehicle positioned to turn about its own diameter.

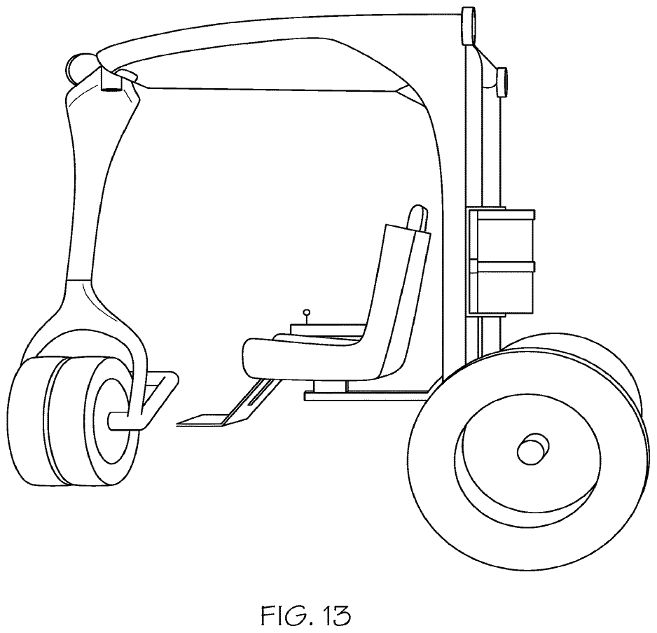

FIG. 14 shows the vehicle right side view.

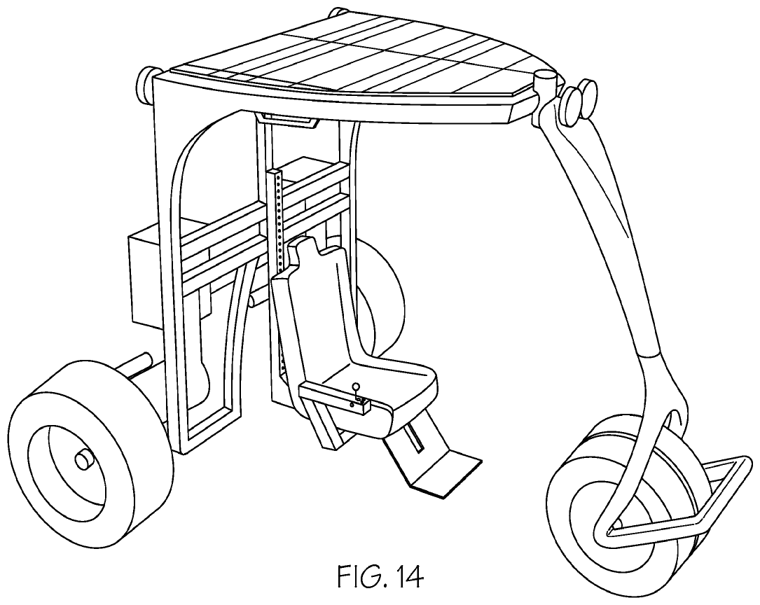

FIG. 15 shows a vehicle four wheel embodiment of the invention.

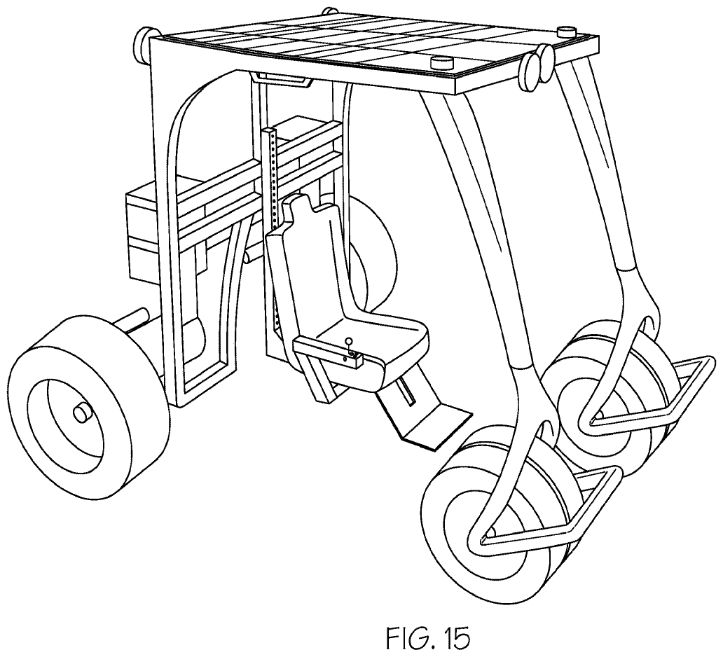

FIG. 16 shows a side perspective view of an alternate embodiment of the vehicle four wheel embodiment of the invention.

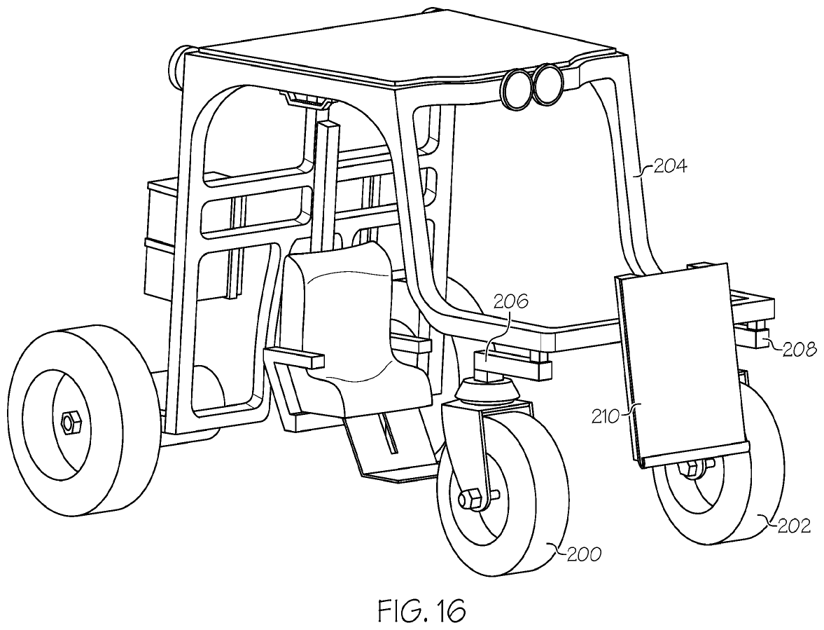

FIG. 17 shows a side view of the embodiment of FIG. 16.

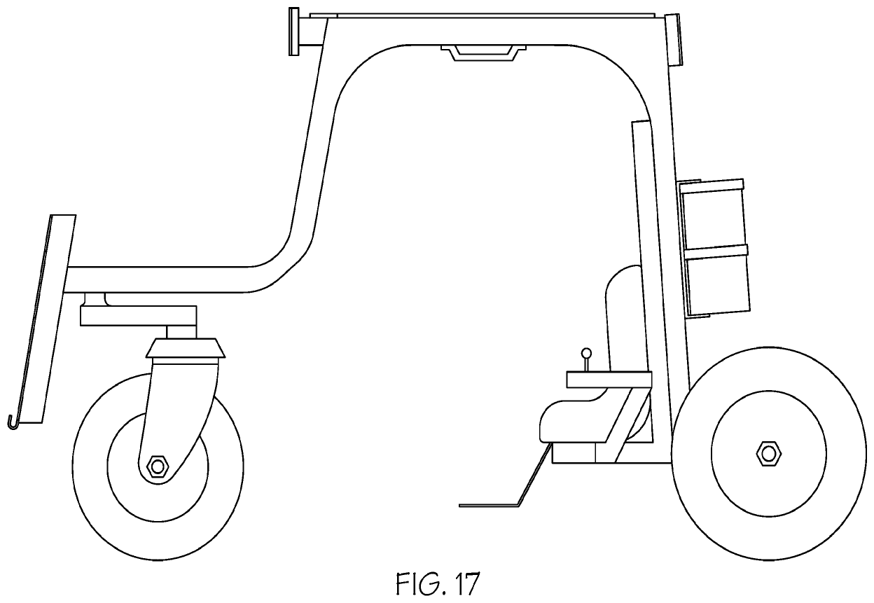

FIG. 18 shows a rear perspective view of the embodiment of FIG. 16.

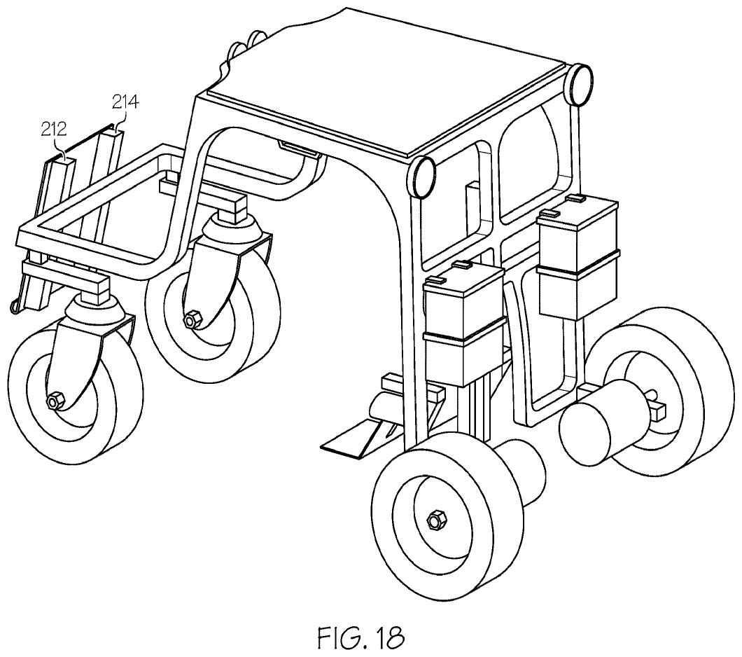

FIG. 19 shows a bottom view of the embodiment of FIG. 16.

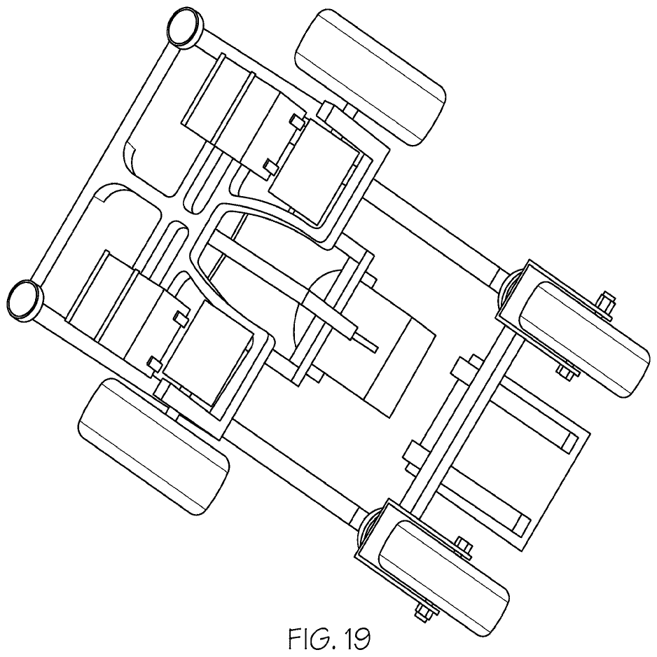

FIG. 20 shows a front view of the embodiment of FIG. 16.

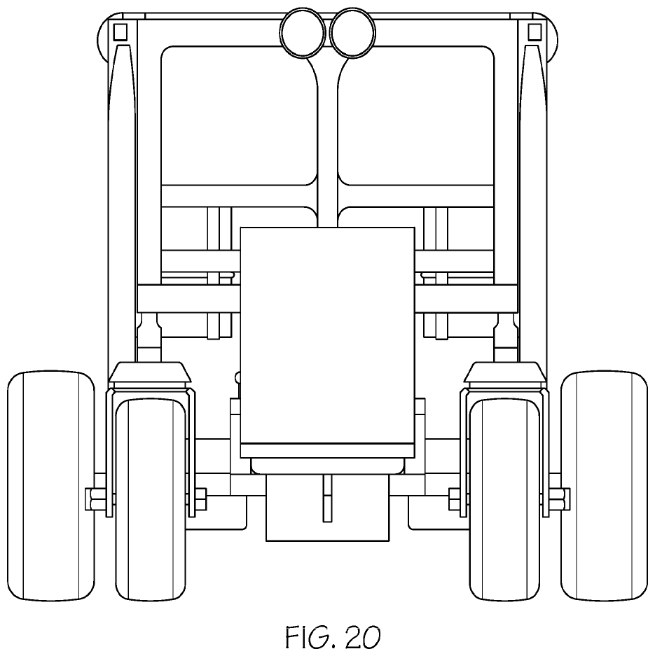

FIG. 21 shows the vehicle in the four wheel configuration with the Internal Combustion Engine (80), Fuel tank (82), exhaust pipe (84), and Plate Frame Supports (212, 214).

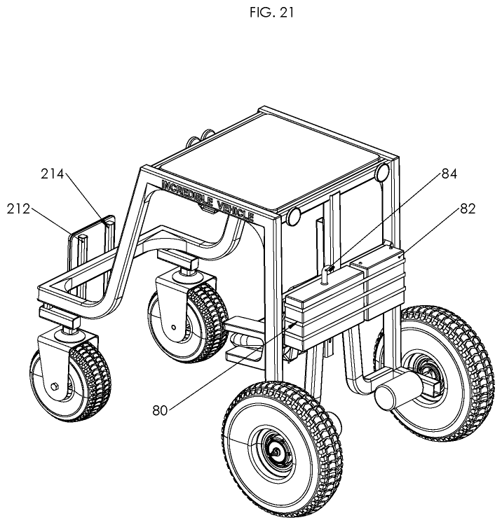

FIG. 22 illustrates a conventional vehicle bus system where the control computer (56) controls valves that determine the amount of hydraulic fluid and pressure sent to the hydraulic motors (94a, 94b) for the rear wheels (22, 24). The internal combustion engine (80) is coupled to the hydraulic pump (90).

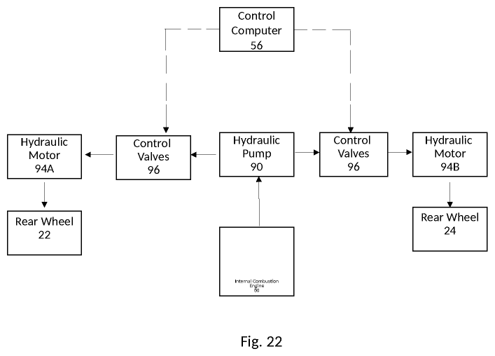

FIG. 23 illustrates a series drive vehicle bus system where the Control Computer (56) controls 2 electric motors that are each individually coupled to each rear wheel. The Internal Combustion Engine (80) provides power to the Generator (100) that is coupled to Electric Motor (28) and Electric Motor (26). Excess energy is stored in Battery (18) and Battery (20).

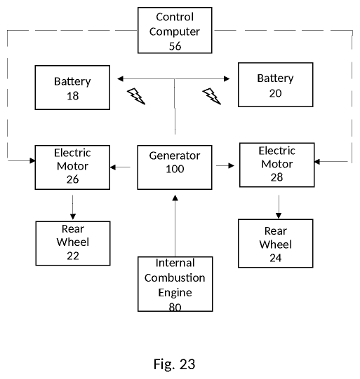

FIG. 24 illustrates a parallel hybrid vehicle bus system where both the electric motor (110) and the Internal Combustion Engine (80) can power a Transmission Clutch (112) that is coupled to the Rear Wheels (22, 24).

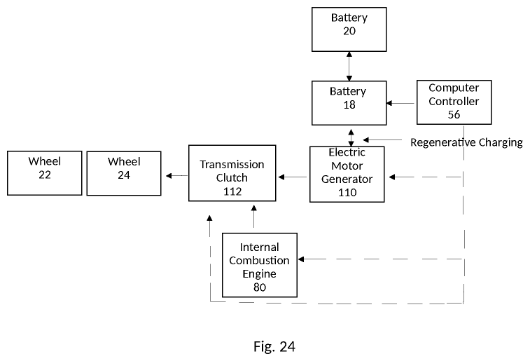

### DETAILED DESCRIPTION OF THE INVENTION

The present invention incorporates the structure of the vehicle disclosed in U.S. patent application Ser. No. 17/865,879, which is incorporated by reference herein in its entirety. The vehicle comprises a frame, including a rear section (12) and a top section (14), that defines an open-sided and open-bottom operator compartment. The top section (14) is configured to provide overhead protection and support auxiliary components such as a solar panel.

A wheel assembly is connected to the frame to provide mobility. In some embodiments, the wheel assembly comprises a three-wheel configuration with two rear drive wheels and a single front caster wheel. In the embodiment forming the basis of the parent application, the wheel assembly comprises a four-wheel configuration, including two rear drive wheels (22, 24) and two front caster wheels. The specific wheel configuration may be varied to suit different operational requirements without departing from the scope of the invention.

A movable chair mechanism is coupled to the frame, providing an operator with dynamic positioning capabilities. The mechanism includes an operator's chair (38) and is configured to move the chair (38) both vertically and horizontally within the open-bottom operator compartment. A set of actuators provides the motive force for the vertical and horizontal movement, allowing an operator to be positioned from ground level to an elevated position of approximately 80 inches, as well as to various lateral positions for optimal access to a work area.

A control system governs the operation of the vehicle. This system is managed by a control computer (56) which receives inputs from a plurality of operator controls. The operator controls are configured to receive operator inputs to direct the operation of the vehicle's propulsion system, steering system, and the movable chair mechanism, thereby providing a centralized and integrated command interface.

### Power Source Configurations

The vehicle may be equipped with different power source configurations to suit different operational requirements and applications.

### Electric Motor Configuration

As described in parent application Ser. No. 17/865,879, which is incorporated herein by reference, the vehicle may be equipped with an electric motor power system. In this configuration, at least one battery (18, 20) is connected to the frame and provides electrical power to one or more electric motors (26, 28). The electric motors are operatively coupled to at least one of the plurality of wheels to provide motive force to the vehicle.

### Internal Combustion Engine Configuration

In an alternative embodiment that expands upon the parent application disclosure, the vehicle may be equipped with an internal combustion engine (80) instead of, or in addition to, the electric motor described in the parent application.

Engine Type: The internal combustion engine (80) may be a gasoline, diesel, propane, or natural gas engine.

Engine Mounting: The internal combustion engine (80) is mounted to the vehicle frame in a location that provides appropriate weight distribution and accessibility for maintenance. The engine is secured to the frame using engine mounting brackets and engine mounts with vibration isolation to reduce vibration transmission to the frame and operator.

Engine Size and Power Output: The internal combustion engine may have various displacement sizes depending on the vehicle size and power requirements.

Fuel System: The internal combustion engine configuration includes a fuel system comprising a fuel tank (82), fuel lines, and fuel delivery components. The fuel tank (82) is mounted to the vehicle frame in a protected location.

Fuel Delivery: The fuel delivery system may comprise a carburetor or a fuel injection system. A fuel pump supplies fuel from the tank (82) to the engine (80).

Ignition and Starting Systems: The engine (80) includes an ignition system appropriate for its type and a starting system comprising an electric starter motor powered by a battery. A charging system comprising an alternator or generator driven by the engine replenishes electrical power to the battery.

Cooling Systems: The cooling system may be an air-cooled system or a liquid-cooled system.

Exhaust System: The internal combustion engine configuration includes an exhaust system (84) to safely route combustion gases away from the engine (80) and operator compartment and to reduce noise.

Drivetrain Configurations: The output shaft of the internal combustion engine (80) is operatively coupled to a drivetrain that transfers power to the vehicle's driven wheels.

Conventional Mechanical Drivetrain: The engine (80) drives the wheels through a conventional mechanical drivetrain comprising a transmission and a differential.

Hydraulic Drivetrain: In an alternative drivetrain configuration, the internal combustion engine (80) drives a hydraulic pump (90) that provides hydraulic pressure to independent hydraulic motors (94a, 94b) coupled to the driven wheels. The hydraulic pump (90), driven by the internal combustion engine (80), converts the engine's rotational mechanical power into hydraulic pressure. Control valves (96) regulate the hydraulic flow to each motor, allowing independent speed and direction control for each wheel, which enables zero-turn capability.

Electric Drivetrain with Generator: In another alternative drivetrain configuration, the internal combustion engine (80) drives a generator (100) that produces electrical power to operate electric motors (26, 28) coupled to the wheels. This is also referred to as a series-drive configuration. The generator (100), driven by the internal combustion engine (80), converts the engine's mechanical power into electrical power. The generator (100) may provide electrical power directly to electric motors (26, 28) or may charge a battery (18, 20) that powers the electric motors.

Integration with Movable Chair Mechanism: The internal combustion engine (80) provides power for the movable chair mechanism, which may be accomplished through hydraulic, electric, or mechanical means.

Hydraulic Chair Actuation: The engine (80) may drive a hydraulic pump providing pressure to hydraulic actuators operating the movable chair mechanism.

Electric Chair Actuation: The engine (80) may drive an alternator or generator that provides electrical power to electric motors operating the movable chair mechanism.

Control Integration: Engine functions are controlled through operator controls integrated with the main vehicle control computer (56).

Advantages of Internal Combustion Engine Configuration: The ICE configuration provides advantages including extended operational range, rapid refueling capability, consistent performance, and greater power output.

### Hybrid Configuration

In yet another embodiment, the vehicle may be equipped with both an electric motor and an internal combustion engine (80) operating in a hybrid configuration.

Series Hybrid Mode: In series hybrid mode, the internal combustion engine (80) drives a generator (100) that produces electrical power to charge a battery (18, 20). Electric motors (26, 28) powered by the battery provide motive force to the wheels.

Parallel Hybrid Mode: In parallel hybrid mode, both the internal combustion engine (80) and an electric motor (110) can independently or simultaneously provide power to drive the wheels through a transmission assembly (112).

Hybrid Advantages: The hybrid configuration provides quiet electric operation, extended range from the ICE, and optimized efficiency.

### Steering System

As described in the parent applications, the vehicle includes a steering system. In configurations with independent wheel motors (hydraulic motors 94a, 94b, or electric motors 26, 28), steering may be accomplished through differential speed control of the drive motors, enabling zero-turn capability.

### Configuration Examples and Vehicle Variants

The modularity of the power source allows the vehicle to be offered in multiple variants, including a base electric configuration, an extended-range ICE configuration, and a flexible hybrid configuration.

### Frame and Structural Considerations

The vehicle frame is designed to accommodate the different power source configurations, with appropriate mounting provisions for either an electric motor system or an internal combustion engine system (80), including its fuel tank (82), exhaust (84), and cooling components.

### Wheels and Drivetrain

The parent applications describe the capability for the rear wheels to be moved outwardly to adjust the rear wheel track width, and this feature is applicable regardless of the power source configuration.

### Movable Chair Mechanism Integration

The movable chair mechanism operates regardless of the power source, receiving power from the vehicle's battery system in an electric configuration, or from the engine (80) via hydraulic or electrical systems in an ICE or hybrid configuration.

What is claimed is:

1. A vehicle comprising:
a frame defining an operator compartment, the operator compartment having an open bottom;
a movable chair attached to a motorized chair movement device configured to move the chair vertically and horizontally within the operator compartment;
a pair of rear driven wheels movably connected to the frame such that a track width between the pair of rear driven wheels is adjustable;
a propulsion system configured to provide motive force to the pair of rear driven wheels;
at least one caster wheel connected to the frame; and
a control computer operably connected to the propulsion system, the motorized chair movement device, and the pair of rear driven wheels to control the adjustment of the track width.

2. The vehicle of claim 1, wherein the propulsion system comprises at least one electric motor and at least one battery electrically connected to at least one electric motor.

3. The vehicle of claim 1, wherein the propulsion system comprises an internal combustion engine.

4. The vehicle of claim 3, wherein the propulsion system further comprises a hydraulic pump driven by the internal combustion engine and a plurality of independent hydraulic motors, each hydraulic motor coupled to one of the pair of rear driven wheels.

5. The vehicle of claim 1, wherein the propulsion system comprises a hybrid system including an internal combustion engine and at least one electric motor.

6. A vehicle comprising:
a frame defining an operator compartment;
a plurality of driven wheels connected to the frame;
at least one caster wheel rotatably connected to the frame;
a movable chair mechanism coupled to the frame and configured to move a chair both vertically and horizontally within the operator compartment;
an internal combustion engine mounted to the frame;
a fuel tank mounted to the frame and operatively connected to the internal combustion engine;
a drivetrain operatively coupling the internal combustion engine to the plurality of driven wheels; and
operator controls for operating the vehicle.

7. The vehicle of claim 6, further comprising:
a fuel delivery system operatively connected between the fuel tank and the internal combustion engine; and
an exhaust system for routing combustion gases away from the operator compartment.

8. The vehicle of claim 6, wherein the drivetrain comprises:
a transmission operatively connected to the internal combustion engine; and
a differential distributing power from the transmission to the plurality of driven wheels.

9. The vehicle of claim 6, wherein the drivetrain comprises:
a hydraulic pump driven by the internal combustion engine; and
a plurality of independent hydraulic motors, each hydraulic motor coupled to one of the plurality of driven wheels and powered by hydraulic pressure from the hydraulic pump.

10. The vehicle of claim 9, wherein the plurality of independent hydraulic motors are configured to rotate the driven wheels in opposite directions to enable the vehicle to turn within its own diameter.

11. The vehicle of claim 6, wherein the drivetrain comprises:
a generator driven by the internal combustion engine; and
a plurality of electric motors, each electric motor coupled to one of the plurality of driven wheels and electrically powered by the generator.

12. The vehicle of claim 6, further comprising a control system operatively connected to the movable chair mechanism, the control system comprising:
a hydraulic pump driven by the internal combustion engine; and
hydraulic actuators operatively coupled to the movable chair mechanism and powered by hydraulic pressure from the hydraulic pump.

13. The vehicle of claim 6, further comprising a control system operatively connected to the movable chair mechanism, the control system comprising:
an alternator driven by the internal combustion engine;
at least one battery charged by the alternator; and
electric motors operatively coupled to the movable chair mechanism and powered by the at least one battery.

14. A vehicle comprising:
a frame defining an operator compartment;
a plurality of driven wheels connected to the frame;
at least one caster wheel rotatably connected to the frame;
a movable chair mechanism coupled to the frame and configured to move a chair both vertically and horizontally within the operator compartment;
an internal combustion engine mounted to the frame;
at least one electric motor;
at least one battery electrically connected to the at least one electric motor;
a control system operatively connected to the movable chair mechanism, the internal combustion engine, and the at least one electric motor;
wherein the internal combustion engine and the at least one electric motor are both operatively coupled to provide motive power to the plurality of driven wheels; and
operator controls for operating the vehicle.

15. The vehicle of claim 14, wherein:
the internal combustion engine drives a generator;
the generator provides electrical power to charge the at least one battery; and
the at least one electric motor is powered by the at least one battery and provides motive force to the plurality of driven wheels.

16. The vehicle of claim 14, wherein both the internal combustion engine and the at least one electric motor are operatively coupled to the plurality of driven wheels and can independently or simultaneously provide motive force to the plurality of driven wheels.

17. The vehicle of claim 14, wherein the control system is configured to:
operate the vehicle using only the at least one electric motor during low-speed operation; and
operate the vehicle using the internal combustion engine during high-speed operation or when the at least one battery reaches a predetermined state of charge.
